(19) United States
(12) Patent Application Publication
(10) Pub. No.: US 2024/0239478 A1
(43) Pub. Date: Jul. 18, 2024

(54) SERVOCONTROL FOR CONTROLLING THE POSITION OF A MOVING PART OF AN AIRCRAFT

(71) Applicant: DASSAULT AVIATION, PARIS (FR)

(72) Inventor: Xavier LE ROUX, SAINT CLOUD (FR)

(21) Appl. No.: 18/415,005

(22) Filed: Jan. 17, 2024

(30) Foreign Application Priority Data
Jan. 18, 2023 (FR) FR 23 00458

(51) Int. Cl. B64C 13/50

(52) U.S. Cl. CPC B64C 13/504

(57) ABSTRACT

A servocontrol for controlling the position of a moving part of an aircraft includes a piloting device configured to control a power device according to a displacement control, the piloting device including a piloting unit further including a set of electronic, mechanical and/or hydraulic accessories in fluidic communication with the hydraulic cylinder and a body delimiting a network of tubular cavities fluidically connecting the electronic, mechanical and/or hydraulic accessories. The body includes an external surface, at least a first coupling portion between the network and a hydraulic cylinder and at least a second coupling portion between the network and the hydraulic cylinder and a neutral axis being defined for each tubular cavity. The neutral axis of at least one tubular cavity is curved.

The present disclosure relates to a servocontrol for controlling the position of a moving part of an aircraft.

### BACKGROUND

The present disclosure further relates to an architecture for controlling the position of the moving part, comprising such a servocontrol and a method for making the servocontrol.

In a known manner, aircraft servocontrols are intended for precise control of the position of a moving part of the aircraft, in particular the position of a control surface of the aircraft, in particular an elevator or a rudder located on the tail fin, or that of ailerons or flaps located on the wings.

Such servocontrols comprise a power device mechanically linked to the moving part and a piloting device receiving flight controls and piloting the power device according to said controls. The power device comprises at least one hydraulic cylinder able to cooperate with the moving part and the piloting device comprises at least one piloting unit which is fluidically, mechanically and electrically connected to the hydraulic cylinder.

Usually, the piloting unit comprises a body delimiting a network of tubular cavities fluidically connecting electronic, mechanical and/or hydraulic accessories as well as the hydraulic cylinder. In such servocontrols, the tubular cavities are directly hollowed out in the body, in particular by machining.

### SUMMARY

However, the known servocontrols are not entirely satisfactory. Indeed, a piloting unit of such a servocontrol usually comprises a complex network of tubular cavities connecting many electronic, mechanical and/or hydraulic accessories as well as the cylinder. In order to be able to delimit all the many tubular cavities which are needed, the body is voluminous and hence has a significant weight. Furthermore, when the cavities are not straight, it is necessary to make many holes for making linear paths intersect (usually at 90°), which further increases the needed volume of the body.

However, the weight and overall size of the servocontrols has to be in line with very strict specifications, in particular according to the location thereof within the aircraft. There is thus a need to reduce the overall size and the weight of the servocontrols of the prior art.

A goal of the present disclosure is then to provide a servocontrol the weight and the overall size of which are reduced.

To this end, the subject matter of the present disclosure is a servocontrol for controlling the position of a moving part of an aircraft, comprising:
a power device configured to move the moving part, the power device comprising at least one hydraulic cylinder extending along a cylinder axis; and
a piloting device configured to control the power device according to a movement command for the moving part received from a device for generating the movement command for the moving part, the piloting device comprising at least one piloting unit comprising:
   a set of electronic, mechanical and/or hydraulic accessories in fluidic communication with the hydraulic cylinder; and
   a body delimiting a network of tubular cavities fluidically connecting the electronic, mechanical and/or hydraulic accessories as well as the hydraulic cylinder, the body comprising an external surface, at least a first coupling portion for coupling the network and the hydraulic cylinder and at least a second coupling portion for coupling the network and the hydraulic cylinder, a neutral axis being defined for each tubular cavity;
wherein the neutral axis of at least one tubular cavity is curved.

According to other particular embodiments of the present disclosure, the servocontrol has one or a plurality of the following features, taken individually or according to all technically possible combinations:
the body of at least one piloting unit is made by additive manufacturing;
at least a part of the cylinder is made of a first material, the body of the at least one piloting unit being made of a second material distinct from the first material;
the first material is an aluminum alloy, the second material being a titanium alloy;
the radius of curvature of at least one curved neutral axis is continuously differentiable;
each tubular cavity has no sharp edge between the ends thereof;
at least one tubular cavity, in particular the at least one tubular cavity the neutral axis of which is curved, has no bifurcation and/or tap-off between the ends thereof;
each tubular cavity extends between two ends, respectively, of connection to:
the at least one first coupling portion;
the at least one second coupling portion; or
an electronic, mechanical and/or hydraulic accessory;
the at least one curved neutral axis extending along the shortest path between the two ends thereof, the shortest path being restricted by the presence of the other tubular cavities, of the electronic, mechanical and/or hydraulic accessories and of the external surface;
the body comprises at least one shaped portion, the external surface of the shaped portion matching the shape of at least one electronic, mechanical and/or hydraulic accessory and/or of at least one tubular cavity, in particular of the at least one tubular cavity the neutral axis of which is curved; and
the shaped portion of the body has a thickness, taken orthogonally with respect to the external surface of the shaped portion between the external surface and:
the nearest tubular cavity; or
the nearest electronic, mechanical and/or hydraulic accessory;
the thickness being comprised between 1 mm and 10 mm, preferentially between 1 mm and 5 mm.

The present disclosure further relates to an architecture for controlling the position of a moving part of an aircraft, comprising:
a device for generating a movement command for the moving part configured to generate a movement command for the moving part; and
a servocontrol as defined above, for controlling the position of the moving part, according to the movement command for the moving part.

The present disclosure further relates to a method for making a servocontrol as described hereinabove, comprising the following steps:
forming at least one hydraulic cylinder of the power device;
making a blank of the body of at least one piloting unit by additive manufacturing so that at least one tubular cavity has a curved neutral axis;
making the body of at least one piloting unit by machining the blank;
forming the at least one piloting unit of the piloting device by installing of electronic, mechanical and/or hydraulic accessories in the body;
assembling the power device and of the piloting device to form the servocontrol.

According to other particular embodiments of the present disclosure, the method of making the servocontrol has one or a plurality of the following features, taken individually or according to all technically possible combinations:
the step of making the blank of the body of the at least one piloting unit does not use any additive manufacturing support;
the blank of the body extends along a main direction from the rear to the front, the main direction being parallel to the cylinder axis when the power device and the piloting device are assembled,
the additive manufacturing being performed along the main direction from the rear to the front during the step of making the blank of the body of the at least one piloting unit,
the blank of the body having at least a cantilevered portion,
any surface of the at least one cantilevered portion oriented substantially rearward with respect to the main direction having an angle of less than or equal to 45° with respect to the main direction; and
during the making of the body of the at least one piloting unit, the surfaces of the at least one cantilevered portion oriented substantially rearward with respect to the main direction are machined to the final shape thereof.

The present disclosure also relates to a servocontrol for controlling the position of a moving part of an aircraft, comprising:
a power device configured to move the moving part, the power device comprising at least one hydraulic cylinder extending along a cylinder axis; and
a piloting device configured to control the power device according to a movement command for the moving part received from a device for generating the movement command for the moving part, the piloting device comprising at least one piloting unit comprising:
   a set of electronic, mechanical and/or hydraulic accessories in fluidic communication with the hydraulic cylinder; and
   a body delimiting a network of tubular cavities fluidically connecting the electronic, mechanical and/or hydraulic accessories as well as the hydraulic cylinder, a neutral axis being defined for each tubular cavity;
at least a part of the at least one hydraulic cylinder is made of a first material, the body of the at least one piloting unit being made of a second material distinct from the first material.

According to other particular embodiments of the present disclosure, the servocontrol has one or a plurality of the following features, taken individually or according to all technically possible combinations:
the neutral axis of at least one tubular cavity is curved;
the body of at least one piloting unit is made by additive manufacturing;
the first material is an aluminum alloy, the second material is a titanium alloy;
the servocontrol comprises a coupling device for coupling the power device and the piloting device, the coupling device including at least one coupling piece between the network of tubular cavities and the hydraulic cylinder, the at least one coupling piece being movable with respect to the body of the piloting unit and/or with respect to the hydraulic cylinder so as to permit a differential expansion of the body of the piloting unit and of the hydraulic cylinder with respect to each other;
the hydraulic cylinder comprises a cylinder barrel extending along the cylinder axis and delimiting a chamber, a rod extending along the cylinder axis in the chamber and a piston mounted on the rod in the chamber,
at least one amongst the cylinder barrel of the hydraulic cylinder and the body of the piloting unit comprising a cylindrical coupling cavity in fluidic communication with the network of tubular cavities or the chamber of the hydraulic cylinder respectively,
the at least one coupling piece being arranged so as to be movable in translation in the cylindrical coupling cavity during the differential expansion of the body of the piloting unit and of the hydraulic cylinder with respect to each other;
the cylindrical coupling cavity extending along an axis substantially parallel to the cylinder axis, the at least one coupling piece being movable in translation in the cylindrical coupling cavity along the cylinder axis;
the cylindrical coupling cavity being delimited by an internal wall,
the at least one coupling piece comprising a cylindrical portion delimiting a coupling pipe and extending into the cylindrical coupling cavity, and at least one annular protrusion cooperating with the inner wall of the cylindrical coupling cavity so as to couple in a leak-tight way, the network of tubular cavities of the piloting unit and the hydraulic cylinder; and
the power device comprises at least one additional hydraulic cylinder identical to the hydraulic cylinder and extending along an additional cylinder axis substantially parallel to the cylinder axis; and
the piloting device comprises at least one additional piloting unit identical to the piloting unit, the at least one additional piloting unit being associated with the at least one additional hydraulic cylinder;
the curved neutral axis having a continuously differentiable curvature;
the at least one tubular cavity the neutral axis of which is curved having no sharp edge between the ends thereof;
at least one tubular cavity, in particular the at least one tubular cavity the neutral axis of which is curved, having no bifurcation and/or tap-off between the ends thereof;
the coupling device further comprising at least two screws, the coupling piece further comprising two flanges each formed by a plate comprising a hole for letting the screw through, the power device and the piloting device each comprising at least two through-holes for screws, each screw extending through the through-holes of the power device, of the piloting device and of the coupling device.

The present disclosure further relates to an architecture for controlling the position of a moving part of an aircraft, comprising:
a device for generating a movement command for the moving part configured to generate a movement command for the moving part; and
a servocontrol as defined hereinabove intended to control the position of the moving part, according to the movement command for the moving part.

The present disclosure further relates to a method for making a servocontrol as described hereinabove, comprising the following steps:
forming at least one hydraulic cylinder of the power device by machining at least one block of the first material;
making a blank of the body of the at least one piloting unit by additive manufacturing from the second material;
making the body of the at least one piloting unit by machining the blank;
forming the at least one piloting unit of the piloting device by installing electronic, mechanical and/or hydraulic accessories in the body;
assembling the power device and of the piloting device in order to form the servocontrol.

According to other particular embodiments of the present disclosure, the method of making the servocontrol has one or a plurality of the following features, taken individually or according to all technically possible combinations:
the blank of the body comprises at least one tubular cavity the neutral axis of which is curved; and
the assembly step comprises the arrangement of at least one coupling device between the power device and the piloting device, the arrangement of the at least one coupling device comprising the arrangement of a coupling piece between the network of tubular cavities and the hydraulic cylinder, the at least one coupling piece being movable with respect to the body of the piloting unit and/or with respect to the hydraulic cylinder in order to permit the differential expansion of the body of the piloting unit and of the hydraulic cylinder with respect to each other.

Furthermore, the present disclosure relates to a series of servocontrols as described hereinbelow:
each servocontrol is intended to control the position of a moving part of the aircraft, each servocontrol comprising a power device and a piloting device, said piloting device and said power device being able to be assembled so as to form, in an assembled configuration, said servocontrol, the series comprising a first servocontrol and a second servocontrol distinct from the first servocontrol, the power device of the second servocontrol being identical to the power device of the first servocontrol, the piloting device of the second servocontrol being different from the piloting device of the first servocontrol, or/and
the series comprising a third servocontrol distinct from the first servocontrol, the power device of the third servocontrol being different from the power device of the first servocontrol, the piloting device of the third servocontrol being identical to the piloting device of the first servocontrol.

According to particular embodiments of the present disclosure, the servocontrol series has one or a plurality of the following features, taken individually or according to all technically possible combinations:
the hydraulic cylinder of each power device comprises a first ball joint fixed in translation along the cylinder axis and a second ball joint intended to be rigidly attached to the moving part and movable in translation along the cylinder axis, the first ball joint being movable in rotation about a first axis of rotation substantially orthogonal to the cylinder axis, the second ball joint being movable in rotation about a second axis of rotation substantially orthogonal to the cylinder axis, the first and second axes of rotation being separated along the cylinder axis by a center distance, the power device of the first servocontrol having at least one differentiating feature with respect to the power device of the third servocontrol, the at least one differentiating feature being taken from the following list of differentiating features:
the diameter of the hydraulic cylinder; and/or
the stroke of the hydraulic cylinder;
the center distance; and
the body of the piloting unit of the first servocontrol is identical to the body of the piloting unit of the second servocontrol, the set of electronic, mechanical and/or hydraulic accessories of the piloting unit of the first servocontrol being distinct from the set of electronic, mechanical and/or hydraulic accessories of the piloting unit of the second servocontrol.

The present disclosure further relates to a method for making a series of servocontrols, the series being as described hereinabove:
provision of a plurality of distinct power devices;
provision of a plurality of distinct piloting devices;
assembly of a first combination of a power device among the plurality of distinct power devices and a piloting device among the plurality of distinct piloting devices, so as to form a first servocontrol;
assembly of a second combination of one of the plurality of distinct power devices and one of the plurality of distinct power devices, so as to form a second servocontrol, the second combination being distinct from the first combination.

Optionally, the process for producing the servocontrol series is such that the step of providing a plurality of distinct piloting devices comprises the following sub-steps:
provision of a plurality of piloting unit bodies, the bodies being identical;
provision of a plurality of first sets of electronic, mechanical and/or hydraulic accessories and of a plurality of second sets of electronic, mechanical and/or hydraulic accessories, the first sets being distinct from the second sets;
forming a first piloting unit by installing a first set of electronic, mechanical and/or hydraulic accessories in a piloting unit body and without installing of a second set of electronic, mechanical and/or hydraulic accessories;
forming a second piloting unit by installing of a second set of electronic, mechanical and/or hydraulic accessories in a piloting unit body.

### BRIEF SUMMARY OF THE DRAWINGS

Other features and advantages of the present disclosure will appear upon reading the following description, given only as an example, and making reference to the enclosed drawings, wherein:

FIG. 1 is a schematic top view of an example of aircraft comprising a moving part and an architecture for controlling the position of the moving part according to the present disclosure;

FIG. 2 is a schematic top perspective view of a servocontrol according to the present disclosure, which is part of the control architecture shown in FIG. 1;

FIG. 3 is a section view along the section plane identified as III in FIG. 2;

FIG. 4 is a magnified view of the detail identified as IV in FIG. 3;

FIG. 5 is a section view along the section plane identified as V in FIG. 3;

FIG. 6 is a perspective view of a coupling piece of the coupling device of the servocontrol shown in FIG. 2;

FIG. 7 is a schematic representation, on the left-hand side, of an example of the body of a piloting unit according to the prior art and, on the right-hand side, of an example of the body of a piloting unit of the servocontrol shown in FIG. 2;

FIG. 8 is a flowchart illustrating the method of making the servocontrol shown in FIG. 2, according to the present disclosure;

FIG. 9 is a perspective view of a blank of a body of a piloting unit of a servocontrol according to the present disclosure, obtained during the process of making the servocontrol shown in FIG. 8;

FIG. 10 is a perspective view of a body of a piloting unit of a servocontrol according to the present disclosure, obtained by machining the blank shown in FIG. 9;

FIG. 11 is a schematic representation of a series of servocontrols according to the present disclosure;

FIG. 12 is a flowchart illustrating the method of making the servocontrol series shown in FIG. 11, according to the present disclosure.

### DETAILED DESCRIPTION

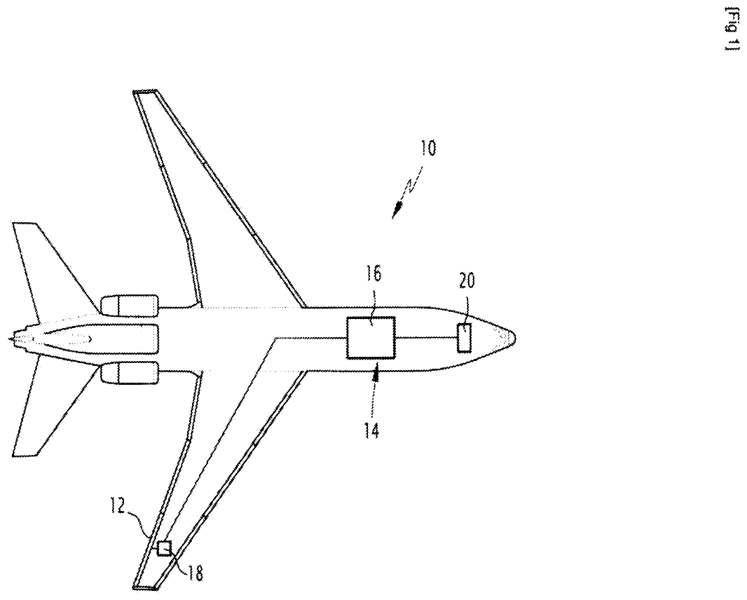

FIG. 1 illustrates an aircraft 10.

The aircraft 10 comprises at least one moving part 12 and an architecture 14 for controlling the position of the moving part 12, according to the present disclosure.

The moving part 12 is e.g. movable between a plurality of distinct positions.

The moving part 12 is e.g. a flight control surface of the aircraft 10. In particular, in the example shown in FIG. 1, the moving part 12 is an aileron of the aircraft 10 mounted movably on a wing of the aircraft 10.

According to examples which are not shown, the moving part 12 is an elevator or a rudder of the aircraft 10, mounted movably on a tail fin of the aircraft 10.

According to another example (not shown), the moving part 12 is a flap of the aircraft 10.

The control architecture 14 comprises a device 16 for generating a movement command for the moving part 12 configured to generate a movement command for the moving part 12 and a servocontrol 18 for controlling the position of the moving part, according to the movement command for the moving part 12.

Advantageously, the control architecture 14 further comprises a control system 20 able to be actuated by a pilot so as to control the position of the moving part 12.

The control system 20 is in particular installed in a cockpit of the aircraft 10.

For example, the control system 20 comprises a control lever for controlling the flight control surfaces of the aircraft 10. In accordance with the example in FIG. 1, the control lever is, e.g., a control lever for the aileron of the aircraft 10.

The device 16 is configured to generate the movement command for the moving part 12 based on an actuation of the control system 20 by the pilot.

The device 16 is e.g. an onboard computer.

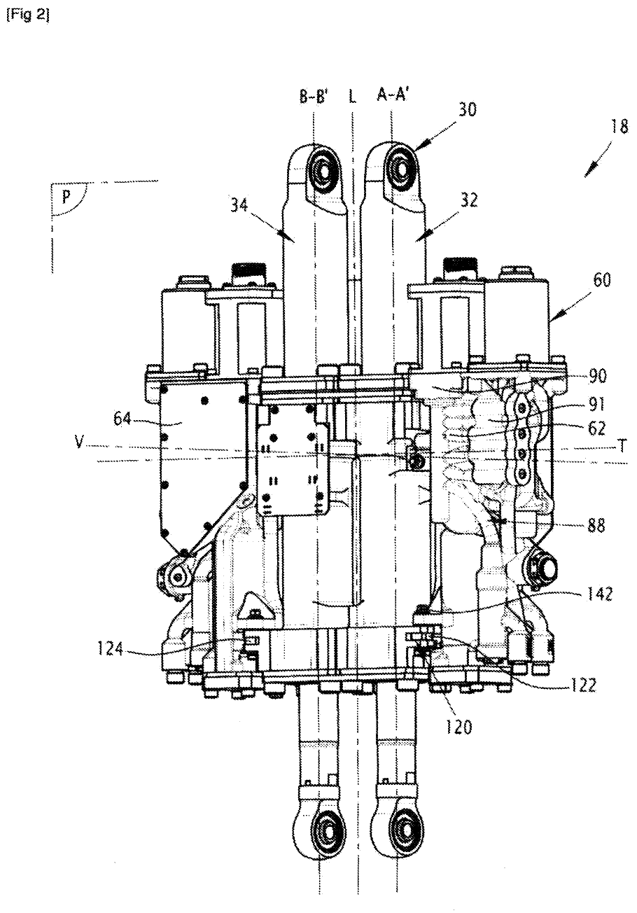

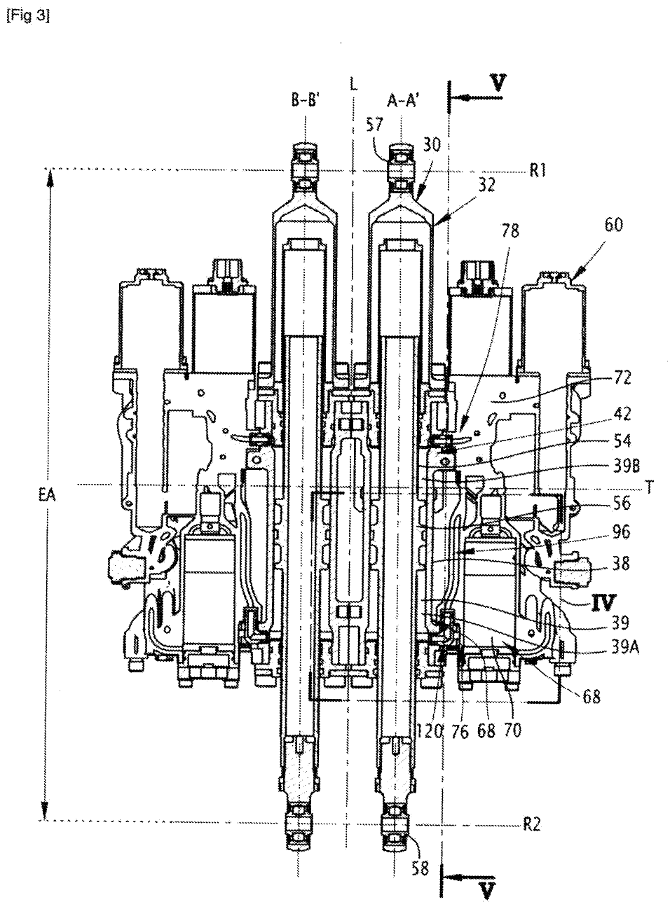

Referring to FIGS. 2 and 3, the servocontrol 18 comprises a power device 30 configured to move the moving part 12 and a piloting device 60 configured to control the power device 30 according to the movement command for the moving part 12 received from the device 16 of the aircraft 10.

Advantageously, as illustrated in FIGS. 2 to 4, the servocontrol 18 further comprises a coupling device 120 between the power device 30 and the piloting device 60.

As illustrated in FIGS. 2 and 3, the power device 30 comprises at least one hydraulic cylinder 32 extending along an cylinder axis A-A′.

We define hereinafter:
a longitudinal axis L parallel to the cylinder axis A-A′;
a transverse axis T orthogonal to the longitudinal axis L so that the servocontrol 18 extends substantially along a plane P comprising the longitudinal axis L and the transverse axis T; and
a vertical axis V orthogonal to the longitudinal axis L and to the transverse axis T.

Advantageously, as can be seen in FIGS. 2 and 3, the power device 30 comprises at least one additional hydraulic cylinder 34 identical to the hydraulic cylinder 32 and extending along an additional cylinder axis B-B′ substantially parallel to the cylinder axis A-A′.

According to the example illustrated in FIGS. 2 and 3, the power device 30 comprises exactly one hydraulic cylinder 32 and an additional hydraulic cylinder 34, attached to each other substantially side by side in the plane P.

Hereinafter, for conciseness, a single hydraulic cylinder 32 is described.

At least a portion of the hydraulic cylinder 32 is made of a first material. According to a particular example, the whole hydraulic cylinder 32 is made of the first material.

Advantageously, the first material is an aluminum alloy, in particular an aluminum alloy 2050, 2024 or 7175.

As illustrated in the example shown in FIGS. 2 to 4, the hydraulic cylinder 32 comprises a cylinder barrel 38, a rod 54 and a piston 56.

Advantageously, the hydraulic cylinder 32 further comprises a first ball joint 57 fixed in translation along the longitudinal axis L and a second ball joint 58 rigidly attached to the moving part 12 and movable in translation along the longitudinal axis L.

The cylinder barrel 38 extends along the cylinder axis A-A′.

The cylinder barrel 38 delimits a chamber 39 and comprises at least a first portion 40 and at least a second portion 42 of coupling for coupling the chamber 52 and a piloting unit 62 of the piloting device 60 (which will be described thereafter).

The chamber 39 comprises an upstream portion 39A and a downstream portion 39B and is intended to receive a fluid.

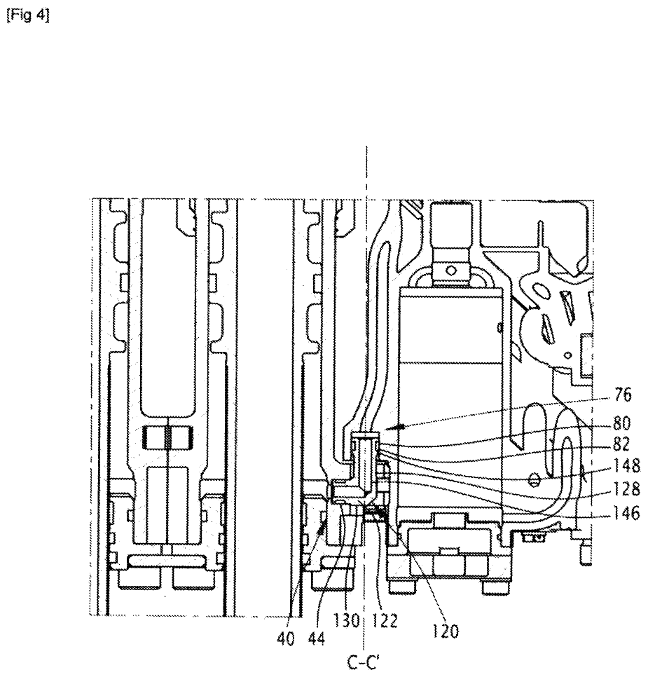

The first 40 and second 42 coupling portions of the cylinder barrel 38 each comprise a cylindrical coupling cavity 44 fluidically connected to the chamber 39 and to the piloting unit 62, in particular to a network 96 of tubular cavities 98 of the piloting unit (which will be described thereafter). The cylindrical coupling cavity 44 of the first coupling portion 40 of the cylinder barrel 38 is shown in FIG. 4.

Hereinafter, for conciseness and as illustrated in the example of FIGS. 2 to 4, it is considered that the cylinder barrel 38 comprises a single first coupling portion 40 and a single second coupling portion 42.

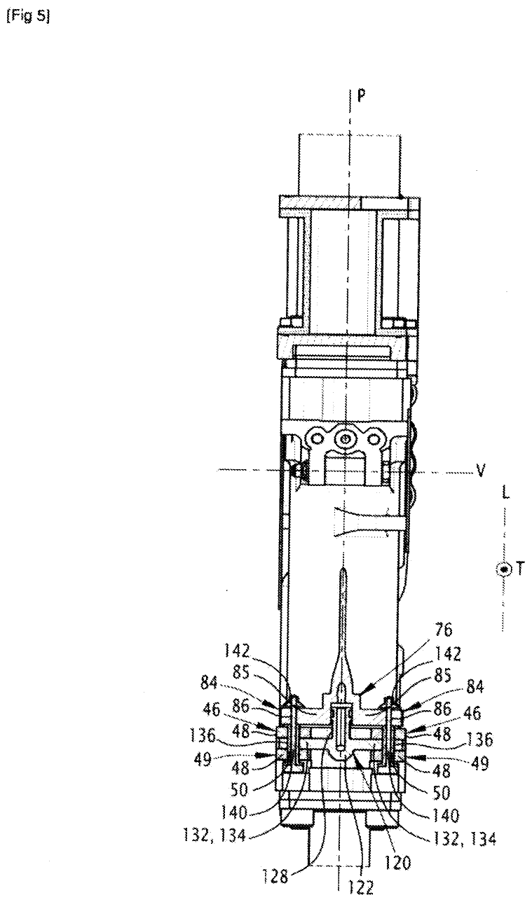

With reference to FIG. 5, the first coupling portion 40 of the cylinder barrel 38 further comprises two members 46 for coupling with the coupling device 120.

The two members 46 are arranged on both sides of the plane P.

Each coupling member 46 comprises two plates 48 each extending substantially in a plane parallel to the transverse axis T and the vertical axis V and separated by a receiver space 49 for receiving a flange 132 of a coupling piece 122 of the coupling device 120. More particularly, the receiver space 49 is dimensioned in such a way that the spacing between the plates 48 corresponds substantially to the thickness of the flange 132 measured along the longitudinal axis L.

Each plate 48 comprises a through-hole 50 for a screw 140 of the coupling device 120.

The rod 54 extends along the cylinder axis A-A′ into the chamber 39.

The piston 56 is mounted on the rod 54 in the chamber 39. Advantageously, the piston 56 is integral with the rod 54.

The piston 56 separates the upstream portion 39A and the downstream portion 39B of the chamber 39.

The first ball joint 57 is fixed in translation along the longitudinal axis L and movable in rotation about a first axis of rotation R1 substantially parallel to the transverse axis T. In particular, the first ball joint 57 is connected to the cylinder barrel 38.

The second ball joint 58 is movable in translation along the longitudinal axis L and movable in rotation about a second axis of rotation R2 substantially parallel to the transverse axis T. In particular, the second ball joint 57 is connected to the piston.

As can be seen in FIG. 3, the first R1 and second R2 axes of rotation are separated along the longitudinal axis L by a center distance EA.

As illustrated in FIGS. 2 and 3, the piloting device 60 comprises at least one piloting unit 62.

Advantageously, the piloting device 60 comprises at least one additional piloting unit 64 identical to the piloting unit 62 and associated with the at least one additional hydraulic cylinder 34.

According to the example illustrated in FIGS. 2 and 3, the piloting device 60 comprises exactly one piloting unit 62 and one additional piloting unit 64.

The piloting unit 62 is attached and connected fluidically, mechanically and electrically to the hydraulic cylinder 32 and the additional piloting unit 64 is attached and connected fluidically to the additional hydraulic cylinder 34.

Hereinafter, for conciseness, a single piloting unit 62 is described.

The piloting unit 62 comprises a set 68 of electronic, mechanical and/or hydraulic accessories 70 and a body 72.

Advantageously, the assembly 68 of accessories 70 depends on specific requirements of the control of the position of the particular moving part 12 controlled by the servocontrol 18. Thereby, e.g. for the control of different moving parts 12, sets 68 corresponding to distinct combinations of accessories 70 are installed.

The electronic, mechanical and/or hydraulic accessories 70 are in fluidic communication with the hydraulic cylinder 32, in particular via a network 96 of tubular cavities 98 extending in the body 72.

Advantageously, the electronic, mechanical and/or hydraulic accessories 70 are arranged in the body 72, in particular in cavities for receiving the accessories 70.

The accessories 70 are e.g. pistons, non-return valves, valves, pressure sensors, flow sensors, temperature sensors, distributors, accumulators.

As illustrated in FIGS. 2, 3, 4 and 7, the body 72 delimits the network 96 of tubular cavities 98.

Advantageously, the body 72 further comprises at least one first coupling portion 76 for coupling the network 96 and the hydraulic cylinder 32, at least one second coupling portion 78 for coupling the network 96 and the hydraulic cylinder 32, at least one shaped portion 88 and an external surface 90.

The body 72 of the piloting unit 62 is made of a second material distinct from the first material, advantageously by additive manufacturing.

Advantageously still, the second material is a titanium alloy, in particular a TA6V titanium alloy.

Advantageously, the first 76 and second 78 coupling portions each comprise a cylindrical coupling cavity 80 in fluidic communication with the chamber 39 of the hydraulic cylinder 32. The cylindrical coupling cavity 80 of the first coupling portion 76 is shown in FIG. 4.

Hereinafter, for conciseness and as illustrated in the example of FIGS. 2 to 5, it is considered that the body 72 comprises a single first coupling portion 76 and a single second coupling portion 78.

For example, as shown in FIGS. 2 to 5, the first coupling portion 76 of the body 72 is in fluidic communication with the first coupling portion 40 of the cylinder barrel 38 and the second coupling portion 78 of the body 72 is in fluid communication with the second coupling portion 42 of the cylinder barrel 38.

The first 76 and second 78 coupling portions of the body 72, in particular the respective cylindrical coupling cavities 80 thereof, are connected by the set 68 of accessories 70.

With reference to FIG. 5, the first coupling portion 76 of the body 72 further comprises two members 84 for coupling with the coupling device 120.

The cylindrical coupling cavity 80 of the first 76 and/or the second 78 coupling portions of the body 72 extends along an axis C-C′ (visible in FIG. 4) substantially parallel to the cylinder axis A-A′.

According to the example illustrated in FIGS. 2 to 5, the cylindrical coupling cavity 80 of the first coupling portion 76 of the body 72 extends along the axis C-C′.

Each cylindrical coupling cavity 80 is delimited by an internal wall 82.

Each coupling member 84 comprises a plate 85 extending substantially in a plane parallel to the transverse axis T and the vertical axis V, in particular parallel to the plane of extension of the plates 48 of the coupling members 46 of the cylinder 32.

Each plate 85 comprises a through-hole 86 for a screw 140 of the coupling device 120.

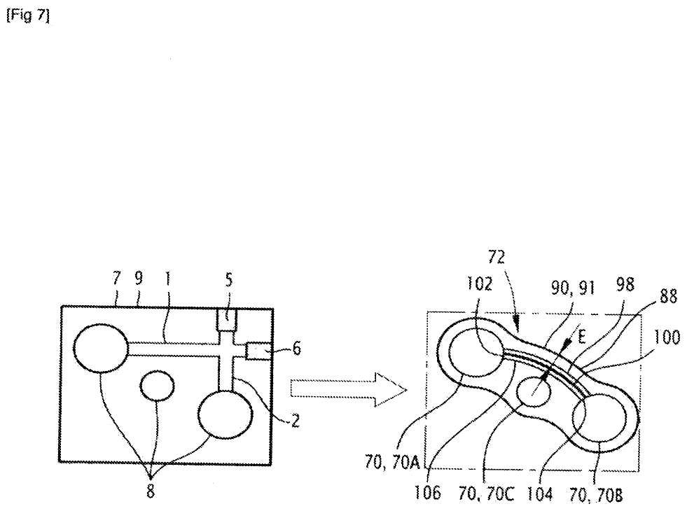

For example, as illustrated in FIGS. 2 and 7, the body 72 comprises at least one shaped portion 88, of which a portion 91 of corresponding external surface 90 matches the shape of at least one mechanical, electronic and/or hydraulic accessory 70 and/or of at least one tubular cavity 98, in particular of at least one tubular cavity 98 having a curved neutral axis 100.

Advantageously, as illustrated in the right-hand part of FIG. 7, the shaped portion 88 has a thickness E taken orthogonally with respect to the corresponding portion 91 of external surface 88 between said external surface portion 88 and:
the nearest tubular cavity 98; or
the nearest electronic, mechanical and/or hydraulic accessory 70;
the thickness E being comprised between 1 mm and 10 mm, preferentially between 1 mm and 5 mm.

As illustrated in FIG. 7 which compares the present disclosure (right-hand part of FIG. 7) and the prior art (left-hand part of FIG. 7), the shaped portion 88 leads to a lower weight and reduces the head losses within the tubular cavity 98. Indeed, the body 72 has less material than the body 7 of the prior art since, in the present disclosure, the surface 90 matches the shape of the accessories 70 and/or of the tubular cavities 98. In comparison, in the prior art, the surface 9 of the body 7 is substantially planar and does not match the shape of either the accessories 8 or the tubular cavities 1, 2.

The network 96 of tubular cavities 98 fluidically connects the accessories 70 to one another as well as the accessories 70 to the hydraulic cylinder 32. More particularly, the network 96 of tubular cavities 98 fluidically connects the cylindrical coupling cavities 80 of the first 76 and second 78 coupling portions and the accessories 70.

Each tubular cavity 98 extends between two ends 102, 104, respectively, for connecting to:
the first coupling portion 76, in particular the cylindrical cavity 80 of the first coupling portion 76;
the second coupling portion 78, in particular the cylindrical cavity 80 of the second coupling portion 78; or
an electronic, mechanical and/or hydraulic accessory 70.

FIG. 7 (right-hand part) illustrates an example wherein a tubular cavity 98, the neutral axis 100 of which is curved, extends between an end 102 for coupling to a first electronic, mechanical and/or hydraulic accessory 70A and a second end 104 for coupling to a second electronic, mechanical and/or hydraulic accessory 70B.

Each tubular cavity 98 is delimited radially by an internal wall 106.

Each tubular cavity 98 has no sharp edge between the ends 102, 104 thereof. The left-hand part of FIG. 7 illustrates an example of the state of the art wherein two tubular cavities 1, 2 have sharp edges between the ends 3, 4 thereof.

At least one tubular cavity 98 has no bifurcation and/or tap-off between the ends 102, 104 thereof. The left-hand part of FIG. 7 illustrates an example of the prior art wherein each tubular cavity 1, 2 has bifurcations and tap-offs 5, 6.

A neutral axis 100 is defined for each tubular cavity 98.

The neutral axis 100 of a tubular cavity 98 corresponds to a line passing through the center of gravity of the cross sections of said tubular cavity 98.

Advantageously, as illustrated in FIG. 7, the neutral axis 100 of at least one tubular cavity 98 is curved. Such a curved neutral axis 100 is obtained in particular by using additive manufacturing during the process of making the servocontrol 18 (discussed in detail thereafter).

For example, a plurality of tubular cavities 98 have a curved neutral axis 100.

In particular, the at least one tubular cavity 98 the neutral axis 100 of which is curved has no sharp edge between the ends 102, 104 thereof and has no bifurcation and/or tap-off between the ends 102, 104 thereof.

Hereinafter, referring to FIG. 7, a single tubular cavity 98 is described the neutral axis 100 of which is curved. It is of course understood that the following applies to all the tubular cavities 98 the neutral axis 100 of which is curved.

For example, as illustrated in FIG. 7, the curved neutral axis 100 extends along the shortest path between the two ends 102, 104 thereof, the shortest path being restricted by the presence of the other tubular cavities 98, of the accessories 70 and of the external surface 90. As illustrated in the example shown in FIG. 7, the shortest path along which the curved neutral axis 100 extends is restricted by the presence of the accessory 70C.

Advantageously, the radius of curvature of the curved neutral axis 100 is continuously differentiable.

With reference to FIGS. 2 to 5, the coupling device 120 comprises at least one coupling piece 122 for coupling the network 96 of tubular cavities 98 of the piloting unit 62 and the hydraulic cylinder 32.

Advantageously, the coupling device 120 includes at least one additional coupling piece 124 identical to the coupling piece 122 and coupling the network 96 of tubular cavities 98 of the additional piloting unit 64 and the additional hydraulic cylinder 34.

According to the example illustrated in FIGS. 2 to 5, the coupling device 120 comprises exactly one coupling piece 122 and one additional coupling piece 124.

Hereinafter, for conciseness, a single coupling piece 122 is described. It is of course understood that the following applies to all of the coupling pieces 122, when the coupling device 120 comprises a plurality of coupling pieces 122 and additional coupling pieces 124.

Advantageously, as can be seen in FIG. 5, the coupling device 120 further comprises, for each coupling piece 122, two screws 140 and two nuts 142.

The coupling piece 122 is movable with respect to the body 72 of the piloting unit 62 and/or with respect to the hydraulic cylinder 32 in order to permit a differential expansion of the body 72 of the piloting unit 62 and of the hydraulic cylinder 32 with respect to each other.

According to the example shown in FIGS. 2 to 5, the coupling piece 122 is arranged so as to be movable in translation in the cylindrical coupling cavity 80 of the first coupling portion 76 during the differential expansion of the body 72 of the piloting unit 62 and of the hydraulic cylinder 32 with respect to each other.

More particularly, the coupling piece 122 is movable in translation in the cylindrical coupling cavity 80 along the cylinder axis A-A′.

In particular, as illustrated in FIGS. 4 to 6, the coupling piece 122 comprises a cylindrical portion 128 for coupling with the cylindrical cavity 80 of the first coupling portion 76 of the piloting unit 62 and a cylindrical portion 130 for coupling with the cylindrical cavity 44 of the first coupling portion 40 of the hydraulic cylinder 32.

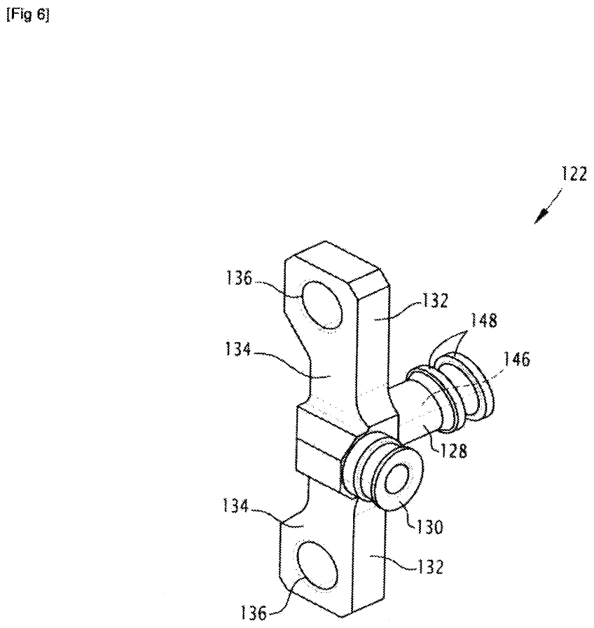

Advantageously, as can be seen in FIGS. 5 and 6, the coupling piece 122 further comprises two flanges 132 extending laterally on both sides of the cylindrical portions 128 and 130, in particular on both sides of the plane P.

The cylindrical coupling portion 128 delimits a coupling pipe 146 and extends into the cylindrical coupling cavity 80.

During the differential expansion of the body 72 of the piloting unit 62 and of the hydraulic cylinder 32 with respect to each other, the cylindrical coupling portion 128 slides in the cylindrical coupling cavity 80.

The cylindrical coupling portion 128 further comprises at least one annular protrusion 148 extending radially from the coupling pipe 146 and cooperating with the inner wall 82 delimiting the cylindrical coupling cavity 80, in order to connect in a leak-tight way the network 96 of tubular cavities 98 of the piloting unit 62 and the hydraulic cylinder 32.

With reference to FIGS. 5 and 6, each flange 132 is formed by a plate 134 extending substantially in a plane parallel to the transverse axis T and the vertical axis V.

Each plate 134 comprises a through-hole 136 for the screw 140.

As can be seen in FIG. 5, each screw 140 extends substantially parallel to the longitudinal axis L through the through-holes 50 for letting through the coupling members 46 of the cylinder 32, through the through-hole 86 of the coupling member 84 of the body 72 of the piloting unit 62 and through the through-hole 136 of the flanges 132 of the coupling piece 122.

Each screw 140 cooperates with a nut 142 in order to rigidly attach the hydraulic cylinder 32, the coupling piece 122 and the piloting unit 62 while permitting a translation parallel to the longitudinal axis L of the hydraulic cylinder 32 and of the piloting unit 62 with respect to each other.

During the differential expansion of the body 72 of the piloting unit 62 and of the hydraulic cylinder 32 with respect to each other, the coupling piece 122 of the coupling device 120 and the coupling members 46, in particular the plates 48, slide together along the screw 140 between the coupling member 84 of the piloting unit 62, in particular the plate 85, and the head of the screw 140.

Thereby, the piloting device 60 and the power device 30 can be made of materials of different types and/or with different features, by being assembled one on top of the other. The coupling piece 122 ensures that the differential expansions likely to occur over the operation temperature range of the aircraft 10, are compensated.

The screws 140 thereby form an element for connecting the cylinder 32, the piloting unit 62 and the coupling piece 122 and for guiding the hydraulic cylinder 32 along in the longitudinal direction L with respect to the piloting unit 62 during the differential expansion.

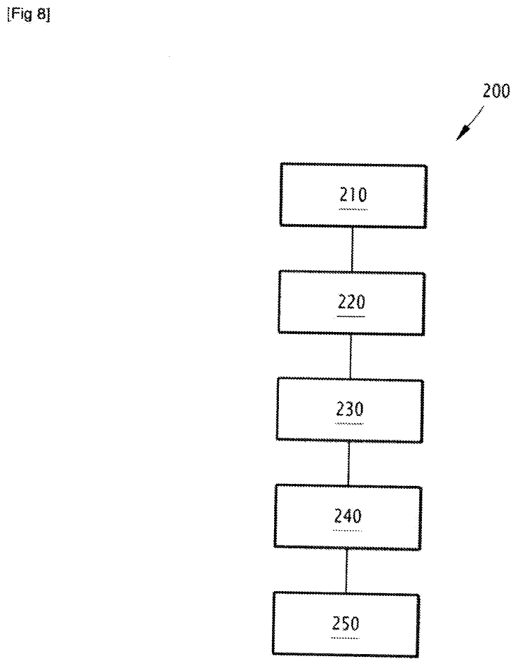

Hereinafter, with reference to FIGS. 8 to 10, a method 200 for making a servocontrol 18 as described hereinabove, is described.

The method 200 comprises a first step 210 of forming the hydraulic cylinder 32 of the power device 30, e.g. by machining at least one block of the first material.

The method 200 further comprises a second step 220 of making a blank 71 of the body 72 of the piloting unit 62 by additive manufacturing, in particular from the second material.

Advantageously, the blank 71 of the body 72 comprises at least one tubular cavity 98 the neutral axis 100 of which is curved. In particular, the second step 220 is carried out in such a way that at least one tubular cavity 98 has a curved neutral axis 100. More particularly, additive manufacturing makes it possible to obtain such a curved neutral axis 100.

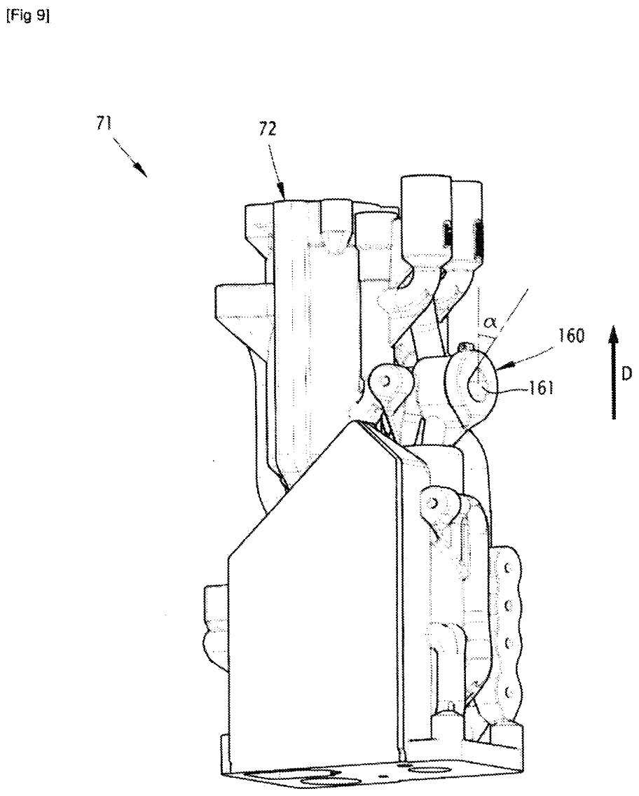

Advantageously still, with reference to FIG. 9, the second step 220 does not use any additive manufacturing supports. “Additive manufacturing supports” refers to elements dedicated to supporting cantilevered parts of the blank 71. More particularly, the blank 71 is self-supported. “Self-supported” means that the blank 71 has no cantilevered parts or has cantilevered parts which do not require special supports.

As illustrated in FIG. 9, the blank 71 of the body 72 extends along a main direction D from the rear to the front. The main direction D is parallel to the cylinder axis A-A′ when the power device 30 and the piloting device 60 are assembled.

Additive manufacturing is carried out along the main direction D from the rear to the front, during the second step 220.

According to the example illustrated in FIG. 9, the blank 71 of the body 72 has at least one cantilevered portion 160. “Cantilevered” means that the portion 160 does not have any immediate support below, i.e. rearward along the main direction D.

According to the example illustrated in FIG. 9, any surface of the at least one portion 160 oriented substantially rearward in the main direction D has an angle α with the main direction D of less than or equal to 45°. Such an angle makes it possible in particular to dispense with additive manufacturing supports.

A cantilevered portion 160 is shown in the example in FIG. 9. The cantilevered portion corresponds to the upper part (forward along the main direction D) of a blank hole 161. The upper part is a cantilevered portion since same has no immediate support underneath. The upper surface of the orifice blank 161, which is oriented substantially rearward along the main direction D, has an angle α with the main direction D, as illustrated.

Again with reference to FIG. 8, the method 200 further comprises a third step 230 of making the body 72 of the piloting unit 62 by machining the blank 71.

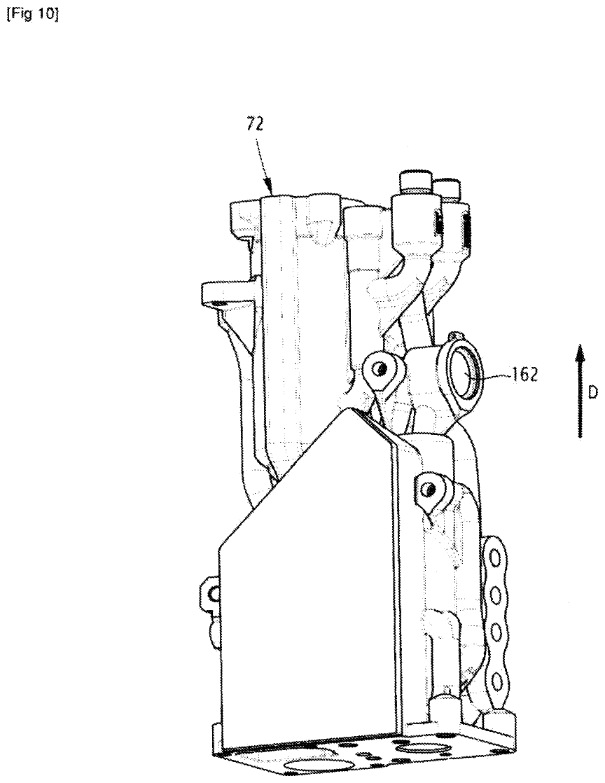

According to the example illustrated in FIG. 10, the surfaces of the at least one portion 160 oriented substantially rearward are machined for imparting the final shape thereof.

FIG. 10 illustrates an example conforming with the example of FIG. 9, wherein the blank hole 161 shown in FIG. 9 was machined for imparting the final shape thereof, i.e. the final shape of a hole 162.

Again with reference to FIG. 8, the method 200 further comprises a fourth step 240 of forming the piloting unit 62 of the piloting device 60 by installing the electronic, mechanical and/or hydraulic accessories 70 in the body 72.

The method 200 further comprises a fifth step 250 of assembling the power device 30 and the piloting device 60 so as to form the servocontrol 18.

Advantageously, the fifth step 250 comprises the arrangement of at least one coupling device 120 between the power device 30 and the piloting device 60.

In particular, the arrangement of the at least one coupling device 120 between the power device 30 and the piloting device 60 comprises the arrangement of a coupling piece 122 between the network 96 of tubular cavities 98 and the hydraulic cylinder 32.

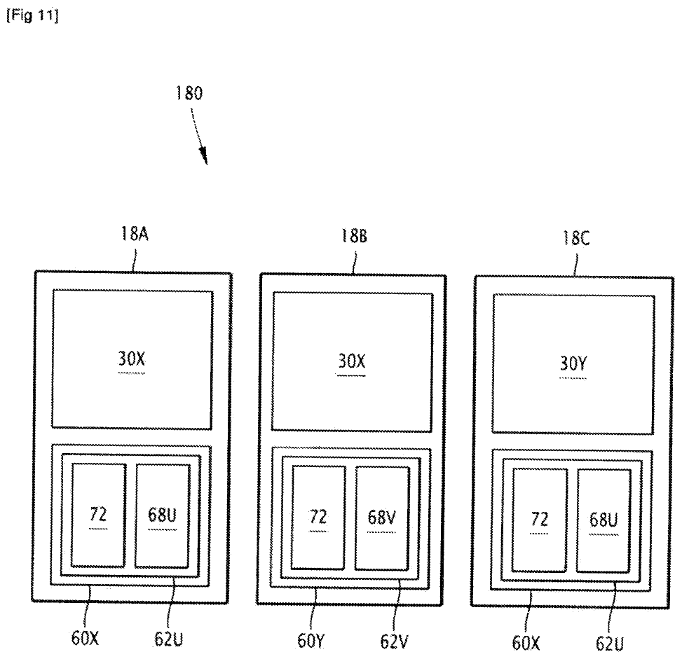

Hereinafter, with reference to FIG. 11, a series 180 of servocontrols 18A, 18B, 18C according to the present disclosure is described.

The servocontrols 18A, 18B, 18C of the 180 series of servocontrols are as described hereinabove.

Each servocontrol 18 of the series 180 of servocontrols 18A, 18B, 18C is intended to control the position of a moving part 12 of the aircraft 10.

Each servocontrol 18 of the series 180 of servocontrols 18A, 18B, 18C comprises a power device 30 and a piloting device 60 able to be assembled for forming, in an assembled configuration, said servocontrol 18.

Advantageously, the series 180 of servocontrols 18A, 18B, 18C comprises a first servocontrol 18A and a second servocontrol 18B distinct from the first servocontrol 18A.

Advantageously still, the series 180 of servocontrols 18A, 18B, 18C comprises a third servocontrol 18C distinct from the first servocontrol 18A.

According to the example shown in FIG. 11, the third servocontrol 18C is also distinct from the second servocontrol 18B.

For example, the first servocontrol 18A is intended to control the position of a first moving part 12, the second servocontrol 18B is intended to control the position of a second moving part 12 distinct from the first moving part 12 and the third servocontrol 18C is intended to control the position of a third moving part 12 distinct from the first and second moving parts 12.

Advantageously, the power device 30X of the second servocontrol 18B is identical to the power device 30X of the first servocontrol 18A and the piloting device 60Y of the second servocontrol 18B is different from the piloting device 60X of the first servocontrol 18A.

More particularly, the piloting unit 62U of the first servocontrol 18A is distinct from the piloting unit 62V of the second servocontrol 18B.

In particular, the body 72 of the piloting unit 62U of the first servocontrol 18A is identical to the body 72 of the piloting unit 62V of the second servocontrol 18B and the set 68U of electronic, mechanical and/or hydraulic accessories 70 of the piloting unit 62U of the first servocontrol 18A is distinct from the set 68V of electronic, mechanical and/or hydraulic accessories 70 of the piloting unit 62V of the second servocontrol 18B.

In other words, the first 18A and second 18B servocontrols are distinguished by the set 68 of electronic, mechanical and/or hydraulic accessories 70 but comprise identical bodies 72, and hence networks 96 of identical tubular cavities 98.

For example, the power device 30Y of the third servocontrol 18C is different from the power device 30X of the first servocontrol 18A and the piloting device 60X of the third servocontrol 18C is identical to the piloting device 60X of the first servocontrol 18A.

In particular, the power device 30X of the first servocontrol 18A has at least one differentiating feature with respect to the power device 30Y of the third servocontrol 18C.

Advantageously, the at least one differentiating feature is taken from the following list of differentiating features:
the diameter of the hydraulic cylinder 32;
the stroke of the hydraulic cylinder 32; and
the center distance EA.

More particularly, the diameter of the hydraulic cylinder 32 corresponds to the diameter of the cylinder barrel 38.

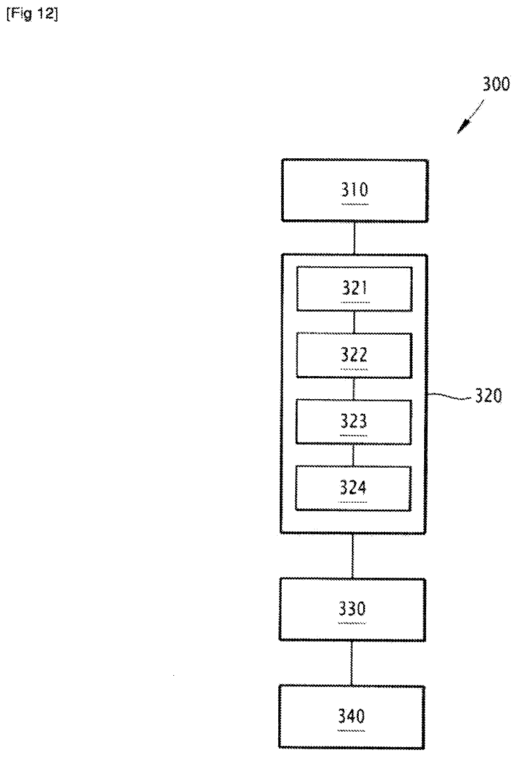

Hereinafter, with reference to FIG. 12, a method 300 for making a series 180 of servocontrols 18A, 18B, 18C as described hereinabove, is described.

The method 300 comprises a first step 310 of making available a plurality of distinct power devices 30X, 30Y.

The method 300 further comprises a second step 320 of making available a plurality of distinct piloting devices 60X, 60Y.

Advantageously, with reference to FIG. 12, the second step 320 comprises a first sub-step 321 for making available a plurality of identical bodies 72 of piloting units 62.

The second step 320 further comprises a second sub-step 322 for providing a plurality of first sets 68U of electronic, mechanical and/or hydraulic accessories 70 and a plurality of second sets 68V of electronic, mechanical and/or hydraulic accessories 70. The first sets 68U are distinct from the second sets 68V.

The second step 320 further comprises a third sub-step 323 of forming a first piloting unit 62U by installing a first set 68U of electronic, mechanical and/or hydraulic accessories 70 in a body 72 of the piloting unit 62 and without installing a second set 68V of electronic, mechanical and/or hydraulic accessories 70.

The second step 320 further comprises a fourth step 324 of forming a second piloting unit 62V by installing a second set 68V of electronic, mechanical and/or hydraulic accessories 70 in a body 72 of the piloting unit 62, e.g. without installing a first set 68U of electronic, mechanical and/or hydraulic accessories 70.

Still with reference to FIG. 12, the method 300 further comprises a third step 330 of assembling a first combination of a power device 30 from among the plurality of distinct power devices 30X, 30Y, 30Z and a piloting device 60 among the plurality of distinct piloting devices 60X, 60Y, 60Z so as to form a first servocontrol 18A.

The method 300 further comprises a fourth step 340 of assembling a second combination of a power device 30 among the plurality of distinct power devices 30X, 30Y, 30Z and a piloting device 60 among the plurality of distinct piloting devices 60X, 60Y, 60Z so as to form a second servocontrol 18B. The second combination is distinct from the first combination.

According to another embodiment, the first material is a steel, in particular a stainless steel or a titanium alloy.

According to yet another embodiment, the second material is a steel, in particular a stainless steel, an Inconel™ or an aluminum alloy.

According to yet another embodiment, the device 16 for generating the movement command for the moving part 12 is a mechanical linkage.

By means of the present disclosure, the servocontrol 18 provides improved adaptability and modularity according to the moving part 12 to be controlled by the use of two distinct materials for the hydraulic cylinder 32 and for the piloting unit 62, respectively.

The servocontrol 18 leads to a lower weight and less manufacturing cycles (time savings).

The use of additive manufacturing for producing the body 72 of the piloting unit 62, and in particular the fact that the body 72 has at least one tubular cavity 98 the neutral axis 100 of which is curved, makes it possible to make the network 96 of tubular cavities 98 more compact, and thus to reduce the weight and the overall size of the body 72.

The fact that the body 72 comprises a shaped portion, also obtained by using additive manufacturing, further reduces the weight and the overall size of the body 72.

The use of an aluminum alloy for the hydraulic cylinder 32 and a titanium alloy for the piloting unit 62 makes it possible to obtain a particularly satisfactory compromise between lightness and reliability (mechanical strength in particular).

By means of the coupling device 120, in particular by means of the coupling piece 122, the differential expansion of the body 72 of the piloting unit 62 and of the hydraulic cylinder 32 with respect to each other is permitted, which reduces the stresses to which the servocontrol 18 is subjected and thus extends the service life thereof.

Finally, the present disclosure makes it possible to easily make a multitude of servocontrols 18 according to various moving parts 12 to be controlled. The servocontrols of the series 180 according to the present disclosure are distinguished by the power device and/or by the piloting device thereof.

The fact that a single identical body 72 is used for each servocontrol 18 of the series 180, facilitates the making of the series.

What is claimed is:

1. A servocontrol for controlling a position of a moving part of an aircraft, comprising:
a power device configured to move the moving part, the power device comprising at least one hydraulic cylinder extending along a cylinder axis; and
a piloting device configured to control the power device according to a movement command for the moving part received from a device for generating the movement command for the moving part, the piloting device comprising at least one piloting unit further comprising:
a set of electronic, mechanical and/or hydraulic accessories in fluidic communication with the hydraulic cylinder; and
a body delimiting a network of tubular cavities fluidically connecting the electronic, mechanical and/or hydraulic accessories as well as the hydraulic cylinder, the body comprising an external surface, at least one first coupling portion for coupling the network and the hydraulic cylinder and at least one second coupling portion for coupling the network and the hydraulic cylinder, a neutral axis being defined for each tubular cavity;
wherein the neutral axis of at least one tubular cavity is curved.

2. The servocontrol according to claim 1, wherein the body of the at least one piloting unit is made by additive manufacturing.

3. The servocontrol according to claim 1, wherein at least a part of the hydraulic cylinder is made of a first material, the body of the at least one piloting unit being made of a second material distinct from the first material.

4. The servocontrol according to claim 3, wherein the first material is an aluminum alloy and the second material is a titanium alloy.

5. The servocontrol according to claim 1, wherein a radius of curvature of the at least one curved neutral axis is continuously differentiable.

6. The servocontrol according to claim 1, wherein each tubular cavity has no sharp edge between ends thereof.

7. The servocontrol according to claim 1, wherein at least one tubular cavity has no bifurcation and/or tap-off between ends thereof.

8. The servocontrol according to claim 7, wherein the at least one tubular cavity having no bifurcation and/or tap-off between the ends thereof is the at least one tubular cavity the neutral axis of which being curved.

9. The servocontrol according to claim 1, wherein each tubular cavity extends between two ends, respectively, of connection to:
the at least one first coupling portion;
the at least one second coupling portion; or
at least one of the electronic, mechanical and/or hydraulic accessories;
the at least one curved neutral axis extending along a shortest path between two ends thereof, the shortest path being restricted by a presence of the other tubular cavities, of the electronic, mechanical and/or hydraulic accessories and of the external surface.

10. The servocontrol according to claim 1, wherein the body comprising at least one shaped portion, the external surface of the shaped portion matching the shape of at least one electronic, mechanical and/or hydraulic accessory and/or of at least one of the tubular cavities.

11. The servocontrol according to claim 10, wherein the at least one tubular cavity, the shape of which being matched by the external surface of the shaped portion, is the at least one tubular cavity the neutral axis of which being curved.

12. The servocontrol according to claim 10, wherein the shaped portion of the body has a thickness, taken orthogonally with respect to the external surface of the shaped portion between the external surface and:
a nearest of the tubular cavities; or
a nearest of the electronic, mechanical and/or hydraulic accessories;
the thickness being comprised between 1 mm and 10 mm.

13. The servocontrol according to claim 12, wherein the thickness is comprised between 1 mm and 5 mm.

14. An architecture for controlling a position of a moving part of an aircraft, comprising:
a device for generating a movement command for the moving part configured to generate a movement command for the moving part; and
the servocontrol according claim 1, for controlling the position of the moving part according to the movement command for the moving part.

15. A method for making the servocontrol according to claim 1, comprising the following steps:
forming the at least one hydraulic cylinder of the power device;
making a blank of the body of the at least one piloting unit by additive manufacturing so that the at least one tubular cavity has the curved neutral axis;
making the body of the at least one piloting unit by machining the blank;
forming the at least one piloting unit of the piloting device by installing of the electronic, mechanical and/or hydraulic accessories in the body;
assembling the power device and the piloting device to form the servocontrol.

16. The method according to claim 15, wherein the step of making the blank of the body of the at least one piloting unit does not use any additive manufacturing support.

17. The method according to claim 16, wherein the blank of the body extends along a main direction from a rear to a front, the main direction being parallel to the cylinder axis when the power device and the piloting device are assembled,
the additive manufacturing being performed along the main direction from the rear to the front during the step of making the blank of the body of the at least one piloting unit,
the blank of the body having at least a cantilevered portion,
any surface of the at least one cantilevered portion oriented substantially rearward with respect to the main direction having an angle less than or equal to 45° with respect to the main direction.

18. The method according to claim 17, wherein, during the making of the body of the at least one piloting unit, the surfaces of the at least one cantilevered portion oriented substantially rearward with respect to the main direction are machined to a final shape thereof.
